(19) United States
(12) Patent Application Publication
(10) Pub. No.: US 2013/0047949 A1
(43) Pub. Date: Feb. 28, 2013

(54) PISTON OF ENGINE

(71) Applicants: Shinichiro Nogawa, Mishima-shi (JP); Daichi Okumura, Yokohama-shi (JP)

(72) Inventors: Shinichiro Nogawa, Mishima-shi (JP); Daichi Okumura, Yokohama-shi (JP)

(73) Assignee: TOYOTA JIDOSHA KABUSHIKI KAISHA, Toyota-shi, Aichi-ken (JP)

(21) Appl. No.: 13/322,511

(22) PCT Filed: Apr. 30, 2010
(86) PCT No.: PCT/JP2010/057692

§ 371 Date: Nov. 25, 2011

(51) Int. Cl. F02F 3/24

(52) U.S. Cl. 123/193.6

(57) ABSTRACT

A piston 1 is employed in an engine 50 where a tumble flow is generated within a combustion chamber 53. The piston 1 includes: a top ring channel 3; and a portion 10 of an outer circumferential portion of a top surface, the portion 10 positioned opposite to an adjacent cylinder of the engine 50, the portion 10 having a raised shape so as not to expose a position P, of a bore wall surface, facing the top ring channel 3 face in the top dead center during at least a period from a time when the piston 1 is positioned at a compression top dead center to a time when a quantity of heat transfer in the combustion chamber 53 is the highest.

### TECHNICAL FIELD

The present invention relates to a piston of an engine, and more particularly, to the piston of a multicylinder engine in which rotational flow is generated in a combustion chamber.

### BACKGROUND ART

There is conventionally known an engine in which rotational flow such as tumble flow or swirl flow is generated in a combustion chamber. In such an engine, the strong rotational flow is generated, thereby increasing the turbulence of the mixed gas. This can improve the combustion speed, and the high speed combustion can improve the mileage. In this regard, for example, Patent Document 1 discloses a technique relevant to an engine in which the tumble flow is generated and relevant to the present invention. In another piston, for example Patent Document 2 or 3 discloses a technique of a structure relevant to the present invention is disclosed.

### PRIOR ART DOCUMENT

### Patent Document

[Patent Document 1] Japanese Patent Application Publication No. 2007-46457

[Patent Document 2] Japanese Patent Application Publication No. 11-200946

[Patent Document 3] Japanese Utility model Application Publication No. 05-38342

### SUMMARY OF THE INVENTION

### Problems to be Solved by the Invention

Incidentally, the temperature of, more particularly, a wall portion formed between cylinders tends to be increased, due to the structure of the multicylinder engine. Specifically, as illustrated in FIG. 8, the temperature of the wall portion illustrated in (a) is higher than the temperature of the wall portion illustrated in (b), in the range of all of the engine driving states. Also, when the engine driving state is changed from a low speed and low load state to a high speed and high load state, the degree where the temperature illustrated in (a) is increased is larger than the degree where the temperature illustrated in (b) is increased. In this regard, the increase in the temperature of the wall portion formed between the cylinders is considered to abnormally consume an engine oil. In particular, there is a concern that this occurs in the high speed and high load driving state in the engine of the high speed combustion. Further, the increase in the temperature might obstruct the improvement in the mileage, in particular, in the engine of the high speed combustion, in order to improve the mileage.

The present invention has been made in view of the above circumstances and has an object to provide a piston of an engine, thereby suitably suppressing the increase in the temperature of a wall portion formed between cylinders of the multicylinder engine.

### Means for Solving the Problems

The present invention to solve the above problem is a piston of an engine, the engine employed as a multicylinder engine in which rotational flow is generated in a combustion chamber, the piston including: a top ring channel; and a portion of an outer circumferential portion of a top surface of the piston, the portion positioned opposite to an adjacent cylinder of the multicylinder engine, the portion having a raised shape so as not to expose a position, of a bore wall surface, facing the top ring channel face in the top dead center during at least a period from a time when the piston is positioned at a compression top dead center to a time when a quantity of heat transfer in the combustion chamber is the highest.

In the present invention, it is preferable that the rotational flow should be tumble flow and the period from the time when the piston is positioned at the compression top dead center to the time when the quantity of heat transfer in the combustion chamber is the highest should include a period from the time when the piston is positioned at the compression top dead center to the time when a crank angle is a given degree from 30 degrees to 50 degrees as setting the compression top dead to an origin, in the forming of the portion.

### Effects of the Invention

According to the prevent invention, a temperature of a wall portion formed between cylinders of a multicylinder engine is suitably suppressed.

### BRIEF DESCRIPTION OF THE DRAWINGS

FIG. 1 is a schematic view of an engine;

FIG. 2 is a horizontal sectional view of a substantial parts of the engine;

FIG. 3 is a perspective view of specifically illustrating a piston of the engine;

FIG. 4 is a sectional view of the piston of the engine taken along line A-A illustrated in FIG. 3;

FIG. 5 is an explanatory view of the piston of the engine;

FIG. 6 is a view of a quantity of heat transferred in a combustion chamber;

FIG. 7 is a view of the quantities of heat transferred in the combustion chamber depending on the tumble ratio; and

FIG. 8 is a view of an example of a temperature in the vicinity of a cylinder depending on an engine driving state.

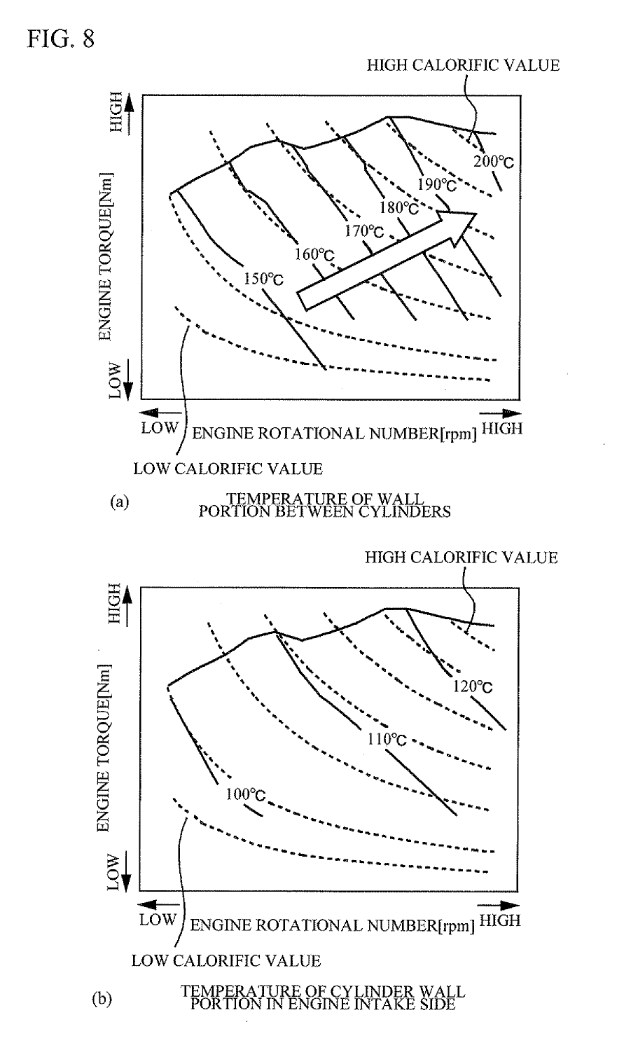

### MODES FOR CARRYING OUT THE INVENTION

In the following, embodiments will be described in detail with reference to the drawings.

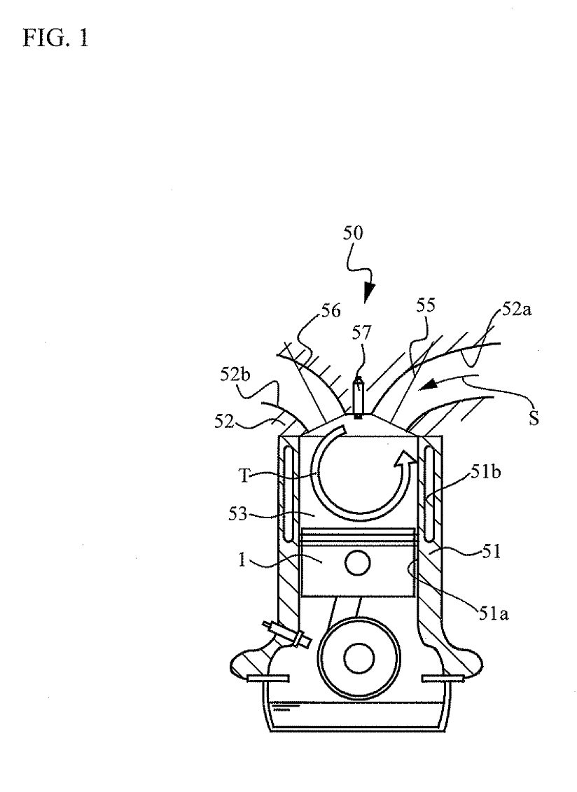

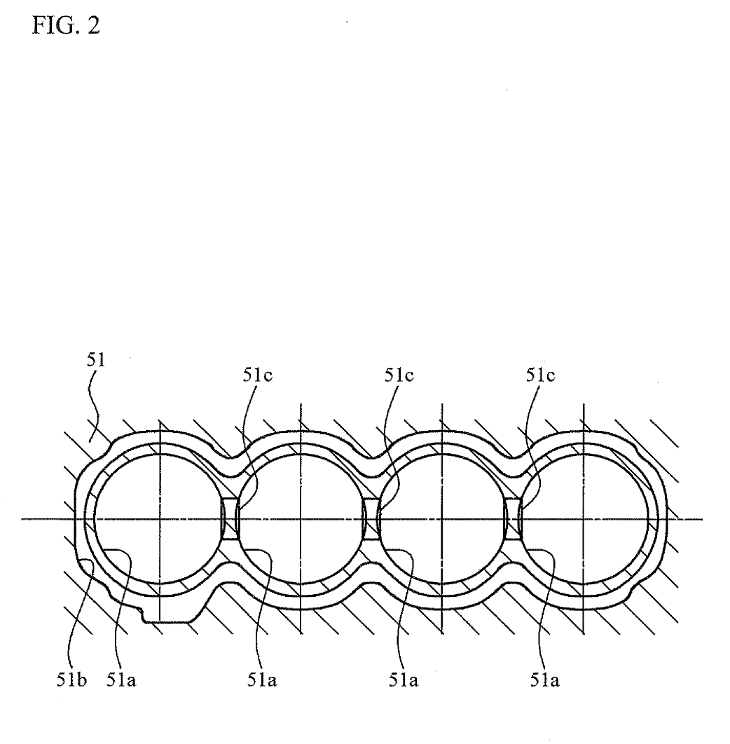

An engine 50 illustrated in FIGS. 1 and 2 is a multicylinder engine with four inline cylinders, and is equipped with a piston 1 of the engine according to the present embodiment (hereinafter, simply referred to as piston), in addition to a cylinder block 51, and a cylinder head 52, an intake valve 55, an exhaust valve 56, and a spark plug 57. The cylinder block 51 is formed with plural (here, four) cylinders 51a and a water jacket 51b. A wall portion 51c is formed between the adjacent cylinders among the plural cylinders 51a. The piston 1 is housed in the cylinder 51a. The cylinder head 52 is secured to a top surface of the cylinder block 51. A combustion chamber 53 is defined as a space surrounded by the piston 1, the cylinder block 51, and the cylinder head 52.

The cylinder head 52 is provided with an intake port 52a and an exhaust port 52b. The intake port 52a introduces an intake air S to the combustion chamber 53, and the exhaust port 52b exhausts a gas in the combustion chamber 53. The intake port 52a corresponds to an intake air introduction portion for introducing an intake air to generate rotational flow in the combustion chamber 53. The intake air S introduced in the combustion chamber 53 forms tumble flow T. In this regard, the tumble flow T is generated with a high tumble ratio (which is the rotation number of the tumble flow T, while the piston 1 is reciprocated once) about 2.0 in the engine 50. The tumble ratio is estimated by AVL simulation. The cylinder head 52 is provided with the intake valve 55 and an exhaust valve 56 for opening and closing respectively the intake port 52a and the exhaust port 52b. Further, the cylinder head 52 is provided with the spark plug 57 projecting on an upper substantial central portion of the combustion chamber 53.

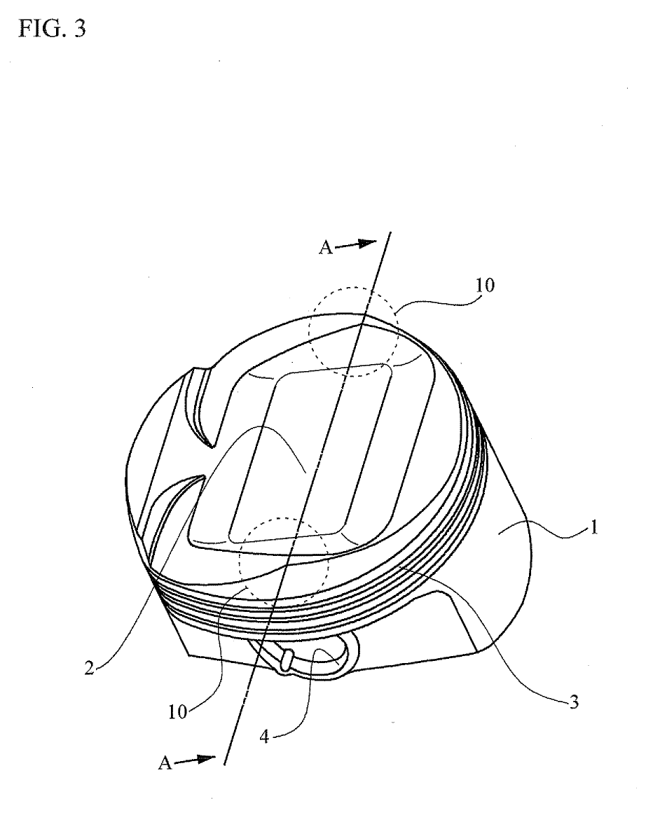

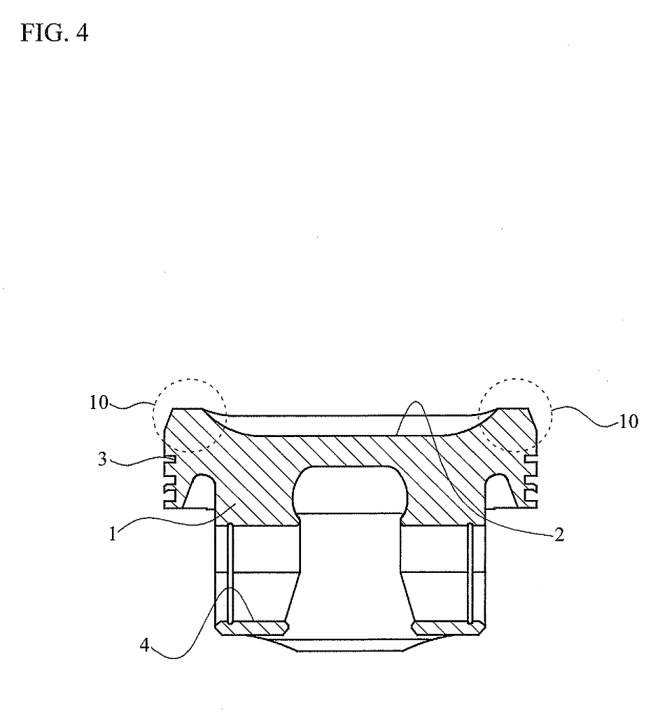

Next, the piston 1 will be described. The piston 1 is provided at its upper surface with a cavity 2 guiding the tumble flow T as illustrated in FIGS. 3 and 4. The cavity 2 is provided for guiding the tumble flow T in the direction of a line passing through the exhaust side and the intake side within the combustion chamber 53. The piston 1 is provided at its circumferential portion with plural (here, three) ring channels. Among them, the ring channel closer to the top surface is a top ring channel 3. Piston rings (not illustrated), respectively installed into the ring channels including the top ring channel 3, each have functions to scrape down an oil on a wall surface of the cylinder 51a as a boa wall surface and to maintain air proof of the combustion chamber 53.

In addition, the piston 1 is formed with a pin boss hole 4. Portions 10 are positioned respectively at both ends in the extending direction of the pin boss hole 4 in an outer circumferential portion of the top surface of the piston 1. Each portion 10 does not have a flat shape but rather a raised shape. Specifically, each portion 10 is formed in such a shape to be gradually raised from both of the intake side and the exhaust side. At least one of the portions 10 is arranged in such a position to face an adjacent cylinder of the engine 50. That is, at least one of the portions 10 is arranged to face the wall portion 51c.

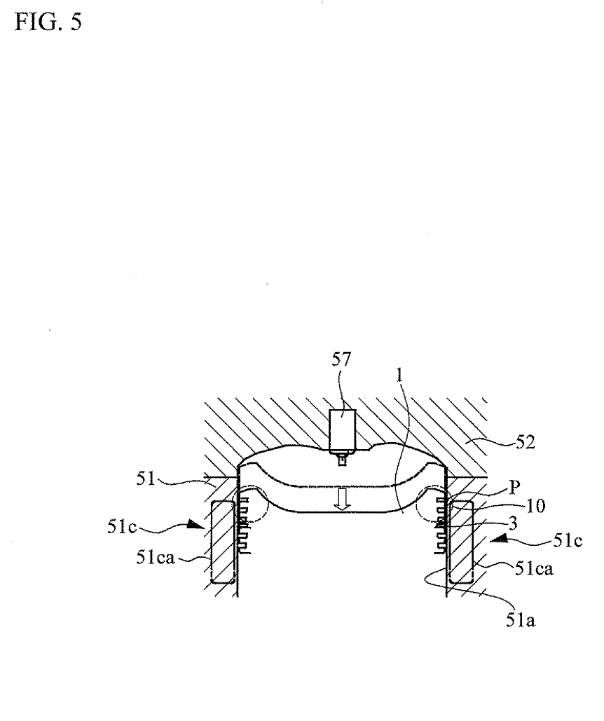

As illustrated in FIG. 5, within the combustion chamber 53, the portions 10 are formed as follows. Herein, the piston 1 is illustrated by a solid line in cases where a crank angle is 40 degrees ATDC, and the piston 1 positioned at the top dead center is illustrated by a dashed line in FIG. 5. Also, the position P indicates the position, of the wall surface of the cylinder 51a, facing the top ring channel 3 in the top dead center. Each portion 10 is formed into such a shape as not to expose the position P of the wall surface of the cylinder 51a during at least a period from the time when the piston 1 is positioned at a compression top dead center to the time when the heat flux indicating the quantity of heat transfer in the combustion chamber 53 is the highest. In this regard, the increase in the temperature of a portion 51ca, lower than the position P, of the wall portion 51c facing the portions, particularly, the portion 10 have to be suppressed in light of the suppression of the abnormal consumption of the oil caused by rising the oil.

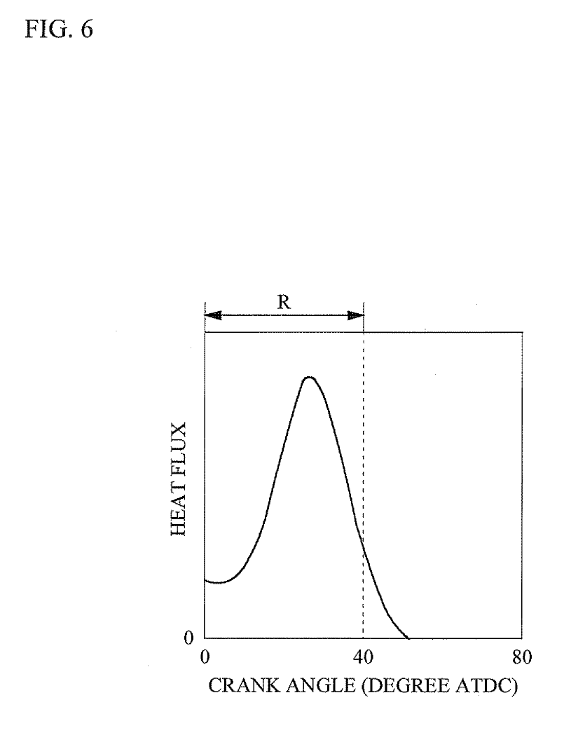

On the other hand, a heat flux changes as illustrated in FIG. 6 in the engine 50. As illustrated in FIG. 6, the heat flux drastically rises just after the compression top dead center, the heat flux becomes peak, and so gradually falls afterward. In this regard, specifically, the heat flux is the highest when the crank angle is about 25 degrees, the heat flux is zero when the crank angle is about 50 degrees ATDC afterward. If the portion 51ca is made not to be exposed while the heat flux is, being generated, the increase in the temperature of the portion 51ca, caused by exposing the portion 51ca to flames or combustion gases, can be suppressed.

For this reason, in order to suppress the increase in the temperature of the portion 51ca, in the forming of the portions 10, it is suitable that the piston 1 should not expose the position P of the wall surface of the cylinder 51a during at least a period from the time when the piston 1 is positioned at the compression top dead center to the time when the heat flux is the highest (herein, 25 degrees ATDC). Further, in forming the portions 10, in light of the change manner in the heat flux as illustrated in FIG. 6, it is preferable that the period from the time when the piston 1 is positioned at the compression top dead center to the time when the heat flux is the highest should include a period from the time of the compression top dead center to a time of a given degrees of a crank angle (from 30 degrees to ATDC 50 degrees ATDC) as setting the compression top dead center to an origin.

In this regard, the given angle is set to be 30 degrees, whereby a range R of the crank angle suppressing the heat transfer to the portion 51ca includes the region where the heat flux is particularly higher around the peal value of the heat flux illustrated in FIG. 6 (from 20 degrees ATDC to 30 degrees ATDC). Also, the given angle is set to 50 degree, whereby the range R can include the heat flux illustrated in FIG. 6.

On the other hand, when the shapes of the portions 10 are formed to be larger, the strengths of the portions 10 might be influenced, and besides the piston 1 might be increased in weight. In this regard, the heat flux mainly increases until 40 degrees ATDC as illustrated in FIG. 6. For this reason, in the forming of the portions 10, in light of the change manner in heat flux illustrated in FIG. 6, it is preferable that the given angle should be set to 40 degrees. In this regard, the given angle is set to 40 degrees, thereby further suppressing the heat transfer to the portion 51ca as compared with cases where the given angle is set to 30 degrees. Additionally, the portions 10 can be reduced in size as compared with cases where the given angle is set to 50 degrees.

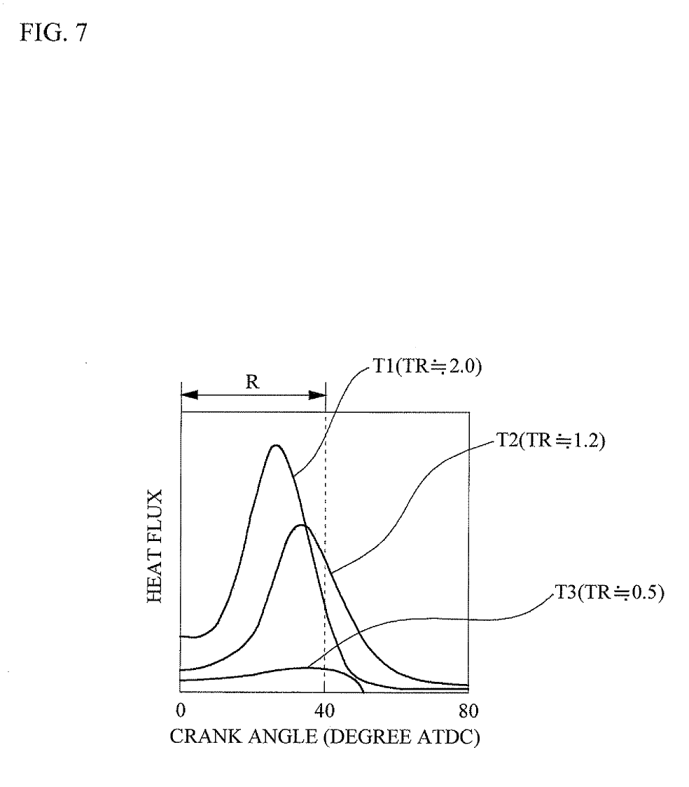

On the other hand, the heat flux changes depending on the tumble ratio as illustrated in FIG. 7. As illustrated in FIG. 7, the crank angle of the heat flux peak is gradually spaced away from the compression top dead center as the tumble ratio (TR) is lower. Also, the heat flux peak value is gradually lower as the tumble ratio is lower. In this regard, in cases where a given angle is set to 40 degrees, the heat flux peak can be included in the range R, not only a case (T1) where the tumble ratio is high (specifically, 2.0) but also a case (T2) where that is middle (specifically, 1.2) and a case (T3) where that is lower (specifically, 0.5). Further, in cases where a given angle is set to 40 degrees, in particular, even in the case T2, the heat transfer to the portion 51ca can be suitably suppressed together with the decrease in the peak value of the heat flux.

For this reason, in cases where a given angle is set to 40 degrees, the adjustability to a wide range including the high tumble ratio can be enhanced.

On the other hand, the crank angle where the heat flux peak is generated comes gradually closer to the compression top dead center as the tumble ratio is higher. Also, the heat flux peak value becomes gradually higher as the tumble ratio is higher. In this regard, when the tumble ratio is set to be higher than 2.0,a given angle is set to be smaller than 40 degrees depending on the tumble ratio. Therefore, the portions 10 can be further reduced in size, as compared with cases where a given angle is set to 40 degrees, while the heat transfer is being suppressed to the same extent in cases where a given angle is set to 40 degrees.

Also, in cases of the tumble ratio lower than 2.0, the heat flux peak value is lower than that of the tumble ratio 2.0. However, a given angle is set to be greater than 40 degrees, thereby further suppressing the heat transfer as compared with cases where a given angle is set to 40 degrees.

Also, in the engine 50, the tumble flow T is generated as the rotational flow in the combustion chamber 53 to be maintained to the latter half of the compression stroke, and is them collapsed. This disturbs the atmosphere in the combustion chamber 53, thereby improving the combustion speed to perform the high speed combustion. In this regard, in the engine 50 performing the high speed combustion, the improvement in the combustion speed increases the temperature of the combustion gas, and the rotational flow causes the thermal boundary layer to be thin. As a result, the heat transfer coefficient becomes large, whereby the temperature of the wall surface of the combustion chamber 53 becomes higher. Also, in the engine 50 performing the high speed combustion, the more rotational flow is strengthened, the more calorific value per unit time increases as the rotational number and the load are higher. Therefore, the heat transfer coefficient becomes much higher. That is, in the engine 50 generating the rotational flow in the combustion chamber 53 and performing the high speed combustion, the above circumstances raise a problem with, in particular, the increase in the temperature of the wall portion 51c. In this regard, the piston 1 which can suppress the increase in the temperature of the portions 51ca is suitable for the engine 50 generating the rotational flow in the combustion chamber 53 and performing the high speed combustion.

While the exemplary embodiments of the present invention have been illustrated in detail, the present invention is not limited to the above-mentioned embodiments, and other embodiments, variations and modifications may be made without departing from the scope of the present invention. For example, the intake port 52a has been described as an intake air introduction portion in the above embodiment. However, the present invention is not limited to these arrangements. For example, the intake air introduction portion may be achieved by a flow control valve, which is provided within the intake port to control the flow of the intake air, or by the combination of the flow control valve and the intake air port. Also, the tumble flow T has been described as the rotational flow in the above embodiment. However, the present invention is not limited to this. The rotational flow may be swirl flow or skew tumble flow.

### DESCRIPTION OF LETTERS OR NUMERALS

1 Piston

3 Top ring channel

50 Engine

51 Cylinder block

51a Cylinder

52 Cylinder head

52a Intake port

53 Combustion chamber

1. A piston of an engine, the engine employed as a multicylinder engine in which rotational flow is generated in a combustion chamber, the piston comprising:
a top ring channel; and
a portion of an outer circumferential portion of a top surface of the piston, the portion positioned opposite to an adjacent cylinder of the multicylinder engine, the portion having a raised shape so as not to expose a position, of a bore wall surface, facing the top ring channel face in the top dead center during at least a period from a time when the piston is positioned at a compression top dead center to a time when a quantity of heat transfer in the combustion chamber is the highest.

2. The piston of the engine of claim 1, wherein:
the rotational flow is tumble flow; and
the period from the time when the piston is positioned at the compression top dead center to the time when the quantity of heat transfer in the combustion chamber is the highest includes a period from the time when the piston is positioned at the compression top dead center to the time when a crank angle is a given degree from 30 degrees to 50 degrees as setting the compression top dead to an origin, in the forming of the portion.
